(19) United States
(12) Patent Application Publication
(10) Pub. No.: US 2023/0292699 A1
(43) Pub. Date: Sep. 21, 2023

(54) Means for Milking Animals

(71) Applicant: Waikato Milking Systems LP, Hamilton (NZ)

(72) Inventors: James Pharoah, Hamilton (NZ); Caleb Grul, Hamilton (NZ); Andy Geissman, Hamilton (NZ); Eric Wisse, Hamilton (NZ); Christopher Metcalfe, Hamilton (NZ); Graeme Mcdougal, Hamilton (NZ); Henry Reed, Hamilton (NZ); Jamie Mikkelson, Hamilton (NZ); Mike Williams, Hamilton (NZ); Peter Dowd, Hamilton (NZ); Tom Morris, Hamilton (NZ)

(21) Appl. No.: 18/020,736

(22) PCT Filed: Nov. 5, 2021
(86) PCT No.: PCT/NZ2021/050196

§ 371 Date: Feb. 10, 2023

(30) Foreign Application Priority Data
Dec. 3, 2020 (NZ) 770625
Sep. 15, 2021 (NZ) 780180

(51) Int. Cl. A01K 1/12; A01J 5/017

(52) U.S. Cl. CPC A01K 1/126; A01J 5/017

(57) ABSTRACT

In one aspect the invention is a milking platform (1) for a species of animal to be milked, comprising a deck divided into a series of bales (17), each bale having side and end barriers and being of sufficient size to receive only one animal (5) for milking. Each has a structure (2) (e.g. a box) arranged such that when the platform is in use with the animal to be milked the structure (2) extends upwards from the deck to a height below the animal's abdomen, is between the forelegs of the animal, starts in front of the forelegs and extends towards, but stops before, the hind legs of the animal such that there is sufficient space to fit a set of milking cups to teats of the animal.

### FIELD OF INVENTION

This invention relates to means for use in milking animals, for example dairy cows by way of a rotary milking platform.

### BACKGROUND

It is known to milk dairy cows as they stand on a rotary milking platform that is divided into a series of bales. In each case the animal is ushered into one of the bales and teat cups are engaged with the udder of the cow. As the platform revolves, milk is drawn from the cow through the teat cups by a vacuum pressure and channelled via a pipeline to a storage vat for collection by a tanker truck. Generally, each cow will be milked in the time it takes the platform to move through one revolution. When milked, the animal is ushered or directly exits out of the bale so it can return to pasture. A new cow enters the same bale and has to be fitted with the same teat cups for milking. This happens constantly as a herd of cows is milked, and so teat cups repeatedly have to be engaged with udders and disengaged. This can be time consuming and contribute to inefficiencies in the milking process. Further, cows are often inclined to turnaround while in their bale at the conclusion of milking in an attempt to walk out forwards rather than by backing up. This can cause delays in getting cows out of their bale so that new cows can take their place for milking.

### OBJECT

It is an object of preferred embodiments of the invention to go at least some way towards addressing the above problems. While this applies to preferred embodiments, the object of the invention per se is simply to provide a useful choice. Therefore, any objects or advantages applicable to preferred embodiments should not be taken as a limitation on claims expressed more broadly.

### Definitions

The term “comprises” or “has”, if and when used in this document in relation to one or more features, should not be seen as excluding the option of there being additional unmentioned features. The same applies to derivative terms such as “comprising” and “having”.

### SUMMARY OF THE INVENTION

Milking Platform with Structure between the Forelegs and below Abdomen

According to one aspect, the invention is a milking platform for a species of animal to be milked (e.g. a cow, goat or sheep), the platform comprising a deck divided into a series of bales, each bale having side and end barriers and being of sufficient size to receive only one animal of the species for milking, each bale also having a structure (e.g. a box) arranged such that when the platform is in use with the animal to be milked it:
a) extends upwards from the deck to a height below the lowest part of the animal's abdomen (excluding the animal's teats) by 5 mm-150 mm;
b) is between the forelegs of the animal; and
c) starts in front of the forelegs and extends towards, but stops before, the hind legs of the animal such that there is sufficient space to fit a set of milking cups to teats of the animal;
   wherein the structure extends to a length of 800 mm-1,400 mm.

Optionally the milking platform is in use with animals to be milked, each animal standing in a respective one of the bales such that the structure:
a) extends upwards from the deck to a height below the lowest part of the animal's abdomen (excluding the animal's teats) by 5 mm-150 mm;
b) is between the forelegs of the animal; and
c) starts in front of the forelegs and extends towards, but stops before, the hind legs of the animal such that there is sufficient space to fit a set of milking cups to teats of the animal;
   wherein the structure extends to a length of 800 mm-1,400 mm.

Optionally the animals are dairy cows, goats or sheep.

Optionally in each case the structure extends to a height marginally below the lowest part of the animal's abdomen (excluding the animal's teats).

Optionally in each case the structure extends to a height below the lowest part of the animal's abdomen (excluding the animal's teats) by-
5 mm-100 mm;
5 mm-50 mm;
5 mm-40 mm;
5 mm-20 mm; or
5 mm-10 mm.

Optionally for each animal the structure extends to a height sufficient to prevent the animal from turning around when in the bale.

Optionally in each case the structure extends upwards from the deck by-
50 mm-1,000 mm;
100 mm-900 mm;
150 mm-800 mm;
200 mm-700 mm;
250 mm-600 mm;
300 mm-500 mm; or
350 mm-450 mm.

Optionally in each case the structure extends to a length of-
200 mm-1,800 mm;
500 mm-1,700 mm;
600 mm-1,600 mm
700 mm-1,500 mm;
900 mm-1,300 mm; or
1,000 mm-1,200 mm.

Optionally in each case the structure extends to a maximum width of-
30 mm-500 mm;
100 mm-400 mm;
150 mm-300 mm;
200 mm-250 mm; or
about 250 mm.

Optionally in each case the structure tapers so that it is wider at one end than the other.

Optionally in each case the structure tapers so that it is higher at one end than the other.

Optionally in each case the structure comprises a housing which in turn comprises positioning means arranged to move a respective set of cups from a stowed position substantially within the housing and under the animal's abdomen when in a normal milking standing milking position, to a pre-engagement position substantially under the animal's udder.

Optionally the stowed position is in front of the cow's udder.

Optionally the pre-engagement position is above and spaced from the platform.

Optionally in each case the positioning means is arranged to move the set of cups to a pre-engagement position adjacent the udder of the animal wherein at least two cups nearest one end of the animal are held upright and higher than at least two cups that are held upright nearest the opposite end of the animal.

Optionally the cups are upright and are in each case vertical or ±20° from vertical.

Optionally the cups are held at least two up and two down and are each at an incline.

### Teat Cup Positioning Means Stowed Under Animal to be Milked

According to a further aspect of the invention there is a milking apparatus, comprising:
a) a set of teat cups adapted to draw milk from a cow (or other animal to be milked); and
b) positioning means comprising a housing that sits on top of a milking platform, the housing extends upwards from the platform to a height below the lowest part of the cow's abdomen (excluding the cow's teats) by 5 mm-150 mm, the housing arranged such that when the platform is in use with the cow to be milked the housing starts in front of the forelegs and extends towards, but stops before, the hind legs of the cow such that the housing extends to a length of 800 mm-1,400 mm and there is sufficient space to fit the set to teats of the cow,
   the positioning means being adapted to move the set of teat cups from a stowed position that is above the platform inside the housing and is at the same time substantially under the cow when the cow is in a normal milking standing position, the movement of the set of teat cups being to a pre-engagement position substantially under the udder of the cow so that a human worker is able to move the set by hand to engage the cow's teats.

Optionally the stowed position is in front of the cow's udder.

Optionally the pre-engagement position is above and spaced from the platform.

Optionally the milking apparatus comprises an enclosure substantially on top of the platform.

Optionally the enclosure is substantially between the front and rear legs of the cow when standing on the platform in the milking position.

Optionally when the cups are in the stowed position they are within the enclosure.

Optionally the set of cups is connected to a milk run-off tube that plays out to enable the set to reach the pre-engagement position and retracts when the set is in the stowed position.

Optionally the milking apparatus comprises means for flushing the tube with cleaning fluid and to hold the tube sufficiently inclined to facilitate draining away of such fluid.

### Teats Cups Height Staggered

According to another aspect of the invention there is provided milking apparatus comprising:
a) a set of teat cups adapted to draw milk from a cow (or other animal to be milked); and
b) positioning means associated with a milking platform arranged to move the set to a pre-engagement position adjacent the udder of the cow wherein at least two cups nearest one end of the cow are held upright and higher than at least two cups that are held upright nearest the opposite end of the cow.

Optionally the cups are upright they are in each case vertical or ±20° from vertical

Optionally the cups are held at least two up and two down, they are each at an incline.

Optionally the positioning means is adapted to move the set of cups from the pre-engagement position to a stowed position where the cups are at substantially the same height.

### Teat Cups Stowed Under Surface of Platform

According to a further aspect, the invention is a milking apparatus, comprising:
a) a set of teat cups adapted to draw milk from a cow (or other animal to be milked); and
b) positioning means associated with a milking platform arranged to move the set from a stowed position under the top surface of platform, under the cow, when in a normal milking standing position to a pre-engagement position under the udder of the cow.

### DRAWINGS

Some preferred embodiments of the invention will now be described by way of example and with reference to the accompanying drawings, of which-

FIG. 1 is a side cross-sectional view of a device for presenting a cluster of teat cups to the udder of a cow for milking;

FIG. 2 is a side cross-sectional view of the device when the teat cups are stowed;

FIG. 3 is a side cross-sectional view of the device when the teat cups are in a pre-engagement position;

FIG. 4 is a side cross-sectional view of the device when the teat cups are about to be engaged with the cows teats;

FIG. 5 is a side view of a milking platform according to a further embodiment of the invention;

FIG. 6 is an isometric end view of the platform of FIG. 5;

FIG. 7 is a longitudinal cross section view taken through B-B of FIG. 6;

FIG. 8 is a side isometric view of the platform of FIGS. 5-7; and

FIG. 9 is an isometric illustration of a still further embodiment of the invention.

### DETAILED DESCRIPTION

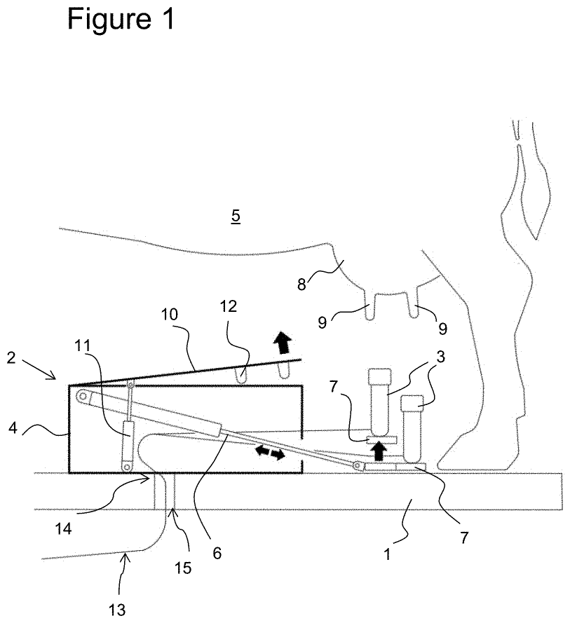

Referring to FIG. 1, a rotary milking platform 1 is fitted with a device 2 for stowing and presenting a cluster of teat cups 3. As shown, the device has a housing 4 that sits on top of the platform 1 between the front and hind legs of a cow 5 when standing within a bale of the platform 1 in a normal milking position.

The device 1 has a mechanically driven arm 6 that can extend out from the housing 4 and subsequently retract to be stowed within the housing. As shown, the arm incorporates a holder 7 for retaining the cups 3, which may for example comprise a ring-like of boss for the cups to sit in. The holder 7 is able to pivot as the arm moves up and down to keep the cups sufficiently upright.

Preferably each teat cup 3 has its own extendable arm 6. The drawings only show one of these but when there are two they function in the same way.

When the device is in use, each arm 6 extends out of the housing 4 towards the cow's hind legs to move its teat cup upwards to align them with the cow's udder 8. From there a human worker grabs the cups 3 and moves them up a little more by hand so that they are immediately underneath the cow's teats 9. Because the cups have an internal vacuum, they automatically suck up onto the teats 9 and stay there while milk is drawn from the cow. At the conclusion of milking the worker manoeuvre's the cups 3 free from the teats 9 and locates them back into engagement with the holder 7. The arms 6 can then retract to stow the cups inside the housing. The cups may be cleaned by a flush of water based cleaning fluid while in or near to the housing 4.

As also shown in FIG. 1, the device 1 has a lid 10 that is opened and closed by a further mechanically driven extendable arm 11. The lid pivots upwards to open when the cups 3 are moved towards the udder, and may be closed when the cups are returned to a stowed position inside the housing 4. The underside of the lid 10 has plugs 12 to cover the upper openings of the cups when they are stowed.

With further reference to FIG. 1, a flexible vacuum hose 13 extends from the cups to draw milk away as the cow is milked. The hose extends through the housing 4 and exits it via an aperture 14 in the base of the device, and passes an aperture 15 in the underside of the milking platform 1.

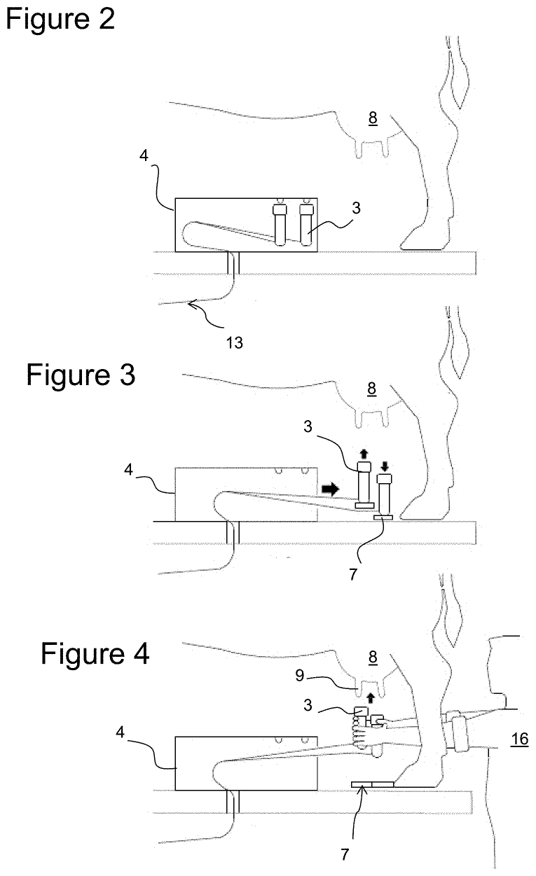

FIGS. 2-4 illustrate, schematically, movement of the cups 3 between a stowed position inside the housing 4 (FIG. 2), a pre-engagement position beneath the udder 8 (FIG. 3) and the position they have just before engaging the teats (FIG. 4). Some of the components mentioned for FIG. 1 have been omitted for ease of explanation.

Referring to FIG. 3, when each arm 6 has extended and located the cups 3 beneath the udder 8 they are ‘height staggered’. In other words the cup nearer one end of the cow (the front end in this example) is held slightly higher than the cup nearer the other end (the rear end in this example). Referring to FIG. 4, this staggering makes it easier for a human worker 16 to grab and manoeuvre the cups upwards close enough to the teats so that the vacuum in the cups takes over and causes them move up a little, snugly against the teats. Preferably the worker does this from a standing position behind the cow. In other embodiments the height staggering of the cups may be such that cups on one side of the cow are higher than those at the other side of the cow.

In FIGS. 1-4 there are just two cups 3 in the cluster. However in other embodiments there may be more, for example four. In the case of four teat cups there will be two for each side of the cow. Those at one end or side of the cow may be height staggered with respect to those on the other end or side, in the same manner described above. In some embodiments of the invention the teat cups of each side will be associated with their own extendable arm 6. For example each pair at each side will have its own arm 6.

In some embodiments of the invention the device 1 may have or be associated with optical sensing equipment that detects the position of the cow's teats when the cow is standing in the normal milking position and senses infection, for example mastitis, whether or not it is sub-clinical in nature.

In further embodiments of the invention the teat cups may be arranged to stow under the top surface of the platform, beneath the cow, when in the normal milking position. From there the cups are moved to the pre-engagement position.

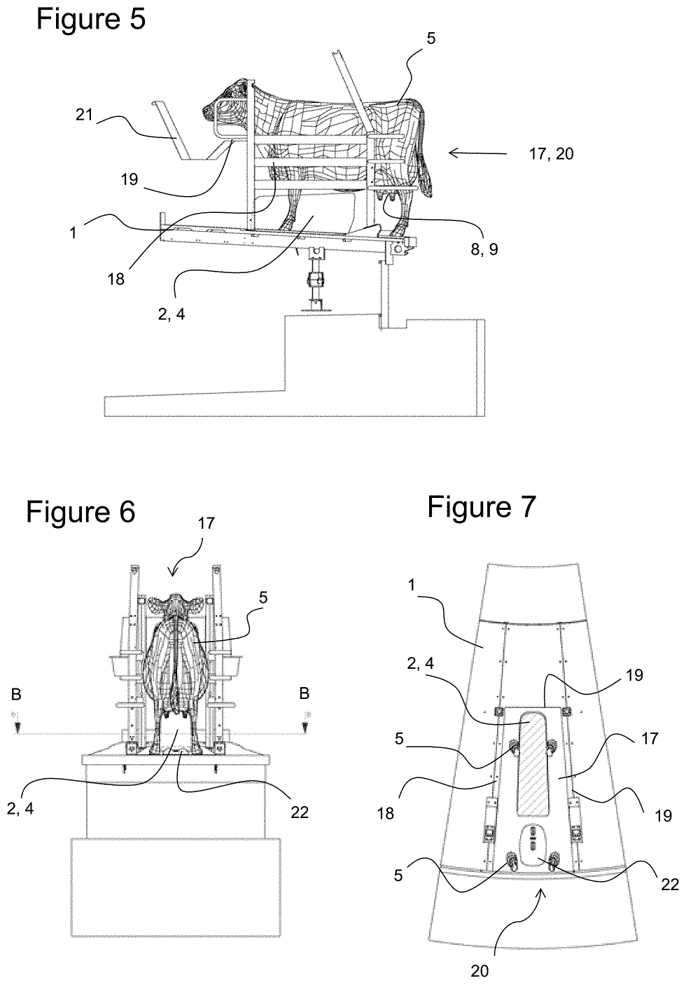

FIGS. 5-8 illustrate a further embodiment of the invention that substantially similar to that described above, but where the housing has different proportions. In describing this embodiment the same reference numbers as above will be used for the same or similar parts.

Referring to FIG. 5, a rotary milking platform 1 for cows is fitted with a device 2 that sits on top of the deck of the platform. As shown, the device 2 starts in front of the cow's forelegs i.e. from a position further into the bale (or further from the entrance 20) than the forelegs. The device 2 has a box-like housing 4 and an internal mechanism adapted to deliver a cluster of teat cups from a stowed position within the housing to a pre-engagement position directly beneath the udder 8 of a cow 5. The mechanism may incorporate a mechanically driven arm and teat cup holder as described previously. From the pre-engagement position a human operator standing just off the platform at the rear end of the cow may manoeuvre the teat cups onto the cow's teats 9, assisted by milking machine vacuum pressure, for milking. After milking, the teat cups are removed and the mechanism returns them to a stowed position inside the housing 4, where they are washed.

FIGS. 6-8 further illustrate the relationship between the cow 5, the device 2 and the platform's deck. The deck is annular and is divided into a series of bales 17, each being of sufficient size to receive one cow for milking at a time. For ease of illustration only one of the bales 17 is shown, but in practice the platform will have many of them, side by side, extending around the annulus. The arrangement is such that during milking the head of each cow faces towards the centre of the platform. Cows move forward into their bale, for milking and have to walk backwards to reverse out when they have been milked.

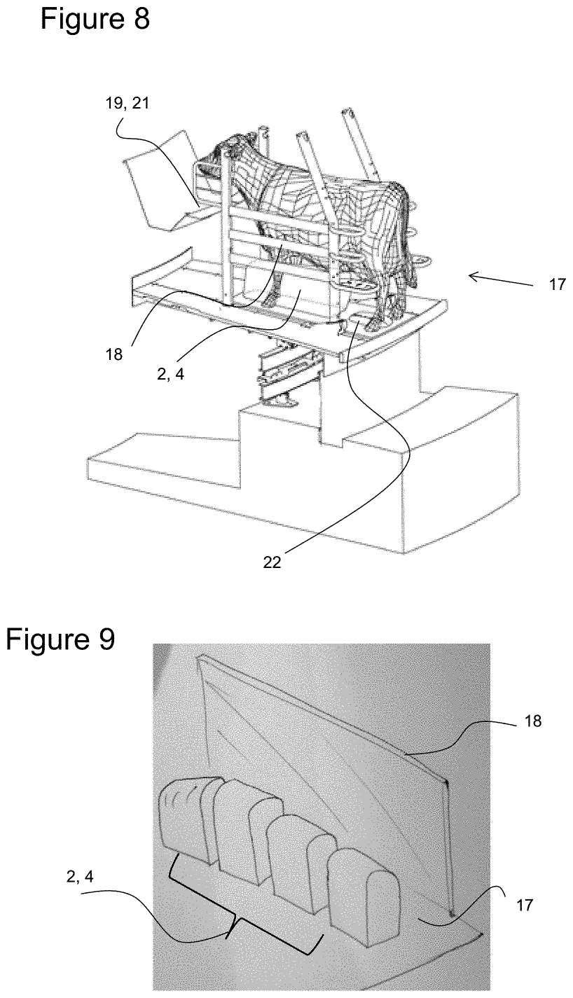

Referring to FIGS. 7-8, each bale has a side barriers (eg bars) 18 and one or more forward barrier 19, arranged so that, when in the bale, the cow is maintained in the correct position for receiving the cluster of teat cups. Bales immediately adjacent one another may share side barriers 18. During milking, each cow is prevented from backing out of the bale by a strap or the like (not shown) that closes the entrance/exit 20 of the bale. The strap is manoeuvred to open the entrance/exit so that the cow, when milked, can leave the bale.

Preferably each bale is associated with a feeding trough 21 arranged so that the cow can be fed while being milked. As shown in FIG. 6-8, the bale also has a spreader 22 at deck level arranged to sit between the cows legs when standing in its milking position. The spreader 22, being a slightly raised pad or section of the deck, makes it uncomfortable for the cow to have its hind legs too close together. By encouraging the cow to keep its hind legs well spread it is easier to fit the teat cups for milking.

As illustrated in FIGS. 6-8, when the cow is in the bale 17 its forelegs straddle the device 2, and, in particular, they straddle its housing 4 (in other words, each foreleg is on a different side of the housing). What this does is prevent, or at least substantially deter, the cow from turning around while in the bale. This is beneficial because if the cow can turn enough to look back, it is more likely that it will be able to land a kick on a human operator fitting or removing the cluster of teat cups, causing pain and/or injury.

Preventing the cow from turning its body completely around in the bale is also beneficial in that it facilitates a more orderly exit of cows from their bales when they have been milked. It is believed that they realise or perceive that they have no option but to walk backwards to exit, given the confined space within the bale due to the space occupied by the device 2. The cow is in effect given a relatively narrow channel-like path for each foreleg to move in, due to the confining effect of the sides of the bale 18 and the sides of the device 2. It is believed that cows realise or perceive that they are not able to turnaround within their bale, i.e. to walk out forwards after being milked, and are therefore not able, or are less inclined, to become wedged in the bale by attempting to turnaround.

It has been surprisingly discovered that confining the space within each bale as above, e.g. so that the cow's legs have to straddle the device 2, serves to significantly reduce the amount of time it takes to get cows to leave their bale after milking. In trials, it was found that on average each cow consistently exits its bale in 3.5 seconds which, as an average, is remarkably fast. It was observed that without the device cows were able to turn partially around relatively easily and become stuck, taking up to 60 seconds to get out of the bales in some cases. In the trials each bale was each about 635 mm at the platform's inner end (brisket bar) and about 703 mm mid-way along. The entrance-exit/tear drop of each bale was about 615 mm wide, and each bale was about 1,800 mm long. The device 2 was about 300 mm wide, about 1,200 mm long and about 400 mm high. The average clearance between the top of the device and the abdomen of the cows (excluding their udder) was approximately 100-150 mm.

As best seen in FIG. 5, the device 2 is of a height that leaves very little space between it and the underside of the cow's abdomen. This makes it difficult, or not possible, for the cow to get its body low enough while in the bale to manoeuvre its head low enough to get stuck beneath the bale's front barrier 19 (e.g. a front bar). Preferably, but not necessarily, the clearance between the device 2 and the abdomen of the cow is less than 100 mm at its smallest, and may for example be as little as 10 mm. Optional dimensions for the device 2 are as noted for the ‘structure’ in the summary of invention section of this specification. As also show, the device 2 sits significantly in front of the teats/udder to give plenty of work room for moving and/or fitting teat cups to the cow.

In alternative embodiments of the invention, substantially the same benefits may be achieved in terms of preventing cows turning when in their bale, and in hastening exit from the bale, by using a structure of the same or similar dimensions to the device 2, but without it incorporating means for stowing and presenting teat cups. The structure may be arranged as one piece or as a series of separate parts spaced on the deck within the bale, as illustrated in FIG. 9. In some embodiments of the invention the structure may be integral with the deck, for example an elongate raised portion of deck at each bale that the forelegs of the cow straddle while being milked. And in some embodiments of the invention the structure may be adjustable in terms of one or more of its height, width and length.

While the FIGS. 5-8 embodiment has been described in relation to milking cows, the size of the various parts, such as the bales 17 and devices 2, can be adjusted if necessary to accommodate different sized four legged animals for milking, for example goats or sheep, etc.

While some forms of the invention have been described by way of example, it should be appreciated that modifications and improvements can be made without departing from the scope of the following claims.

In terms of disclosure, this document envisages and hereby posits any feature mentioned herein in combination with itself or any other feature or features mentioned herein, even if the combination is not claimed.

1. A milking platform for a species of animal to be milked (e.g. a cow, goat or sheep), the platform comprising a deck divided into a series of bales, each bale having side and end barriers and being of sufficient size to receive only one animal of the species for milking, each bale also having a structure (e.g. a box) arranged such that when the platform is in use with the animal to be milked it:
a) extends upwards from the deck to a height below the lowest part of the animal's abdomen (excluding the animal's teats) by 5 mm-150 mm;
b) is between the forelegs of the animal; and
c) starts in front of the forelegs and extends towards, but stops before, the hind legs of the animal such that there is sufficient space to fit a set of milking cups to teats of the animal;
wherein the structure extends to a length of 800 mm-1,400 mm.

2. (canceled)

3. (canceled)

4. A milking platform according to claim 1, wherein the structure extends to a height marginally below the lowest part of the animal's abdomen (excluding the animal's teats).

5. A milking platform according to claim 1, wherein the structure extends to a height below the lowest part of the animal's abdomen (excluding the animal's teats) by
5 mm-100 mm.

6. A milking platform according to claim 1, wherein for each animal the structure extends to a height sufficient to prevent the animal from turning around when in the bale.

7. A milking platform according to claim 1, wherein the structure extends upwards from the deck by
50 mm-1,000 mm.

8. A milking platform according to claim 1, wherein the structure extends to a length of
200 mm-1,800 mm.

9. A milking platform according to claim 1, wherein the structure extends to a maximum width of
30 mm-500 mm.

10. A milking platform according to claim 1, wherein the structure tapers so that it is wider at one end than the other.

11. A milking platform according to claim 1, wherein the structure tapers so that it is higher at one end than the other.

12. A milking platform according to claim 1, wherein the structure comprises a housing which in turn comprises positioning means arranged to move a respective set of teat cups from a stowed position substantially within the housing and under the animal's abdomen when in a normal milking standing milking position, to a pre-engagement position substantially under the animal's udder.

13. A milking platform according to claim 12, wherein the stowed position is in front of the cow's udder.

14. A milking platform according to claim 12, wherein the pre-engagement position is above and spaced from the platform.

15. A milking platform according to claim 12, wherein the positioning means is arranged to move the set of cups to a pre-engagement position adjacent the udder of the animal wherein at least two cups nearest one end of the animal are held upright and higher than at least two cups that are held upright nearest the opposite end of the animal.

16. A milking platform according to claim 15, wherein the cups are upright and are in each case vertical or ±20° from vertical.

17. A milking platform according to claim 16, wherein the cups are held at least two up and two down and are each at an incline.

18. A milking platform according to claim 12, wherein the set of teat cups is adapted to draw milk from the animal, and a human worker is able to move the set by hand to engage the animal's teats when the set of teat cups is in the pre-engagement position.

19. A milking platform according to claim 12, wherein the set of cups is connected to a milk run-off tube that plays out to enable the set to reach the pre-engagement position and retracts when the set is in the stowed position.

20. A milking platform according to claim 19, comprising means for flushing the tube with cleaning fluid and to hold the tube sufficiently inclined to facilitate draining away of such fluid.

21. A milking apparatus, comprising:
a) a set of teat cups adapted to draw milk from a cow; and
b) positioning means comprising a housing that sits on top of a milking platform, the housing extends upwards from the platform to a height below the lowest part of the cow's abdomen (excluding the cow's teats) by 5 mm-150 mm, the housing arranged such that when the platform is in use with the cow to be milked the housing starts in front of the forelegs and extends towards, but stops before, the hind legs of the cow such that the housing extends to a length of 800 mm-1,400 mm and there is sufficient space to fit the set to teats of the cow;
the positioning means being adapted to move the set of teat cups from a stowed position that is above the platform inside the housing and is at the same time substantially under the cow when the cow is in a normal milking standing position, the movement of the set of teat cups being to a pre-engagement position substantially under the udder of the cow so that a human worker is able to move the set by hand to engage the cow's teats.

22. Milking apparatus according to claim 21, wherein the stowed position is in front of the cow's udder.

23. Milking apparatus according to claim 21, wherein the pre-engagement position is above and spaced from the platform.

24. Milking apparatus according to claim 21, wherein the milking apparatus comprises an enclosure substantially on top of the platform.

25. Milking apparatus according to claim 24, wherein the enclosure is substantially between the front and rear legs of the cow when standing on the platform in the milking position.

26. Milking apparatus according to claim 24, wherein when the cups are in the stowed position they are within the enclosure.

27. Milking apparatus according to claim 21, wherein the set of cups is connected to a milk run-off tube that plays out to enable the set to reach the pre-engagement position and retracts when the set is in the stowed position.

28. Milking apparatus according to claim 27, comprising means for flushing the tube with cleaning fluid and to hold the tube sufficiently inclined to facilitate draining away of such fluid.

29. Milking apparatus according to claim 21, wherein the cow is on the platform in order to be milked and the housing starts in front of the forelegs and extends towards, but stops before, the hind legs of the cow.

30. (canceled)

31. (canceled)

32. (canceled)

33. (canceled)

34. (canceled)
